(19) United States
(12) Patent Application Publication
(10) Pub. No.: US 2006/0003109 A1
(43) Pub. Date: Jan. 5, 2006

(54) PROCESS FOR CURING PAINT

(76) Inventors: Markus Bischof, Warthausen (DE); Michael Deger, Blaustein (DE)

Correspondence Address: PENDORF & CUTLIFF, 5111 MEMORIAL HIGHWAY, TAMPA, FL, 33634-7356, US

(21) Appl. No.: 11/174,029

(22) Filed: Jul. 1, 2005

(30) Foreign Application Priority Data
Jul. 1, 2004 (DE) 102004031813.1-11
Sep. 15, 2004 (DE) 102004044534.6-45

(51) Int. Cl. C08F 2/46

(52) U.S. Cl. 427/487

(57) ABSTRACT

Method of producing coating films from coating formulations which are free-radically polymerizable under thermal initiation, characterized in that it comprises at least the following steps: a) coating of the substrate with the coating formulation b) thermally initiated curing of the coating formulation c) elimination of quality deficiencies in the cured coating material d) curing of the coating material to completion by UV exposure, and also to a coating formulation suitable for this method, comprising monomers containing ethylenically unsaturated groups and thermal free-radical initiators, the coating formulation being substantially free from UV initiators and the hardness of the coating material after thermal curing and subsequent UV irradiation being higher by at least 15% than after thermal curing without UV irradiation.

### BACKGROUND OF THE INVENTION

1. Field of the Invention

The invention relates to a method of producing coating films from coating formulations which can be free-radically polymerized under thermal initiation, comprising at least the following steps:
a) coating of the substrate with the coating formulation
b) thermally initiated curing of the coating formulation
c) elimination of quality deficiencies in the cured coating material
d) curing of the coating material to completion by UV exposure,
   and also to a coating formulation suitable for this method, comprising monomers containing ethylenically unsaturated groups and thermal free-radical initiators, the coating formulation being substantially free from UV initiators and the hardness of the coating material after thermal curing and subsequent UV irradiation being higher by at least 15% than after thermal curing without UV irradiation.

2. Related Art of the Invention

Coating formulations which cure thermally and also those which are radiation-curable have already been known for a relatively long time and are employed, inter alia, in the automotive industry for a variety of coating systems. Coating materials of this kind include as substantial components monomers or oligomers that are curable by means of free-radical polymerization, especially acrylates, which act as binders. Depending on the curing method, thermal initiators are used in some cases or photoinitiators are used in some cases.

For the automotive industry more recent times have also seen the development of systems which cure only with induction by light; in other words, substantially UV-curable coating systems. Typical fields of application for coating systems of this kind are also to be found in the electronics, printing, wood processing and paper industries. In contrast to these coating systems, however, the automotive coatings must have substantially greater hardness and scratch resistance. These coatings must also possess a high weathering stability.

Multi-coat vehicle finishes are generally composed of a sequence of two or more functional coats, including a corrosion control coat, produced for example by phosphating or cathodic deposition coating, a primer coat, which is frequently pigmented, a pigmented basecoat, and a final, transparent clearcoat.

UV coating materials have the advantage over their thermally cured counterparts of high hardness and scratch resistance. For instance, EP 540 884 A1 discloses a method of producing multi-coat finishes using free-radically and/or cationically curable polymerizable clearcoat materials. The coating formulations contain UV initiators. The method envisages applying the liquid coating material in the absence of light with wavelengths of below 550 nm and subsequently curing by means of UV light. In addition to the UV cure it is possible to carry out a thermal cure before, during or after UV irradiation. In that case the coating formulation preferably has thermal initiators as well as the photoinitiators.

Another curing method leading to coatings of high scratch resistance was described in DE 197 54 621 A1. Radiation-curing coating materials with binders based on acrylic ester, such as polyurethane acrylates, polyester acrylates, polyether acrylates or epoxy acrylates, are first irradiated with UV or electron beams. This is followed by irradiation with infrared light, the temperatures in the surface layer of the coating climbing to as high as 220° C. Only by this means is the coating baked and attains its ultimate strength.

In the course of the production of extensive coating systems, such as for bodywork parts in the automotive industry, for example, surface defects in the paint film are generally unavoidable. They may be caused, for example, by impurities if the substrate to be coated, deposits of dust or dirt during the coating operation, or impurities from the spraying equipment. Non-uniform application of coating material as well is a source of error that is observed. Normally, therefore, a quality control operation with remediation of coating defects is vital after curing of the coating.

Although in some cases the coating systems cited lead to the desired hardness and strength of the coatings, these properties are very disadvantageous for subsequent reworking of the coating for the purpose of repairing coating defects. For example, the removal of defect sites or the subsequent polishing of the hard coatings is very difficult to carry out.

### SUMMARY OF THE INVENTION

It is therefore an object of the invention to provide a coating material which is suitable for the automotive industry, exhibits high hardness and scratch resistance, and yet in the production method is easy to repair or rework, and particularly to polish.

This object is achieved by means of a method of producing coating films from coating formulations which are free-radically polymerizable under thermal initiation, having the features of claim 1, and also by a method of producing coating films from coating formulations which are free-radically polymerizable under thermal initiation, comprising at least the following steps:
a) coating of the substrate with the coating formulation
b) thermally initiated curing of the coating formulation
c) elimination of quality deficiencies in the cured coating material
d) curing of the coating material to completion by UV exposure,
   and also by a coating formulation suitable for this method, comprising monomers containing ethylenically unsaturated groups and thermal free-radical initiators, having the features of claim 14.

In accordance with the invention it is envisaged, therefore, that the coating attains its ultimate strength in two different curing steps and that quality deficiencies are eliminated before the ultimate hardness is attained in the UV exposure step. The two-stage cure ensures that at the point when quality deficiencies are eliminated the coating has not yet attained its full hardness but instead has attained a hardness or scratch resistance that allows easy remediation.

The step of eliminating quality deficiencies embraces examination for defects or defect sites, and also the various measures for removing the defects and repairing the defect sites. This includes not least the polishing of the coating. The method of the invention leads, after thermal curing, in particular to coatings which are readily polishable. The further measures also include local recoating.

In general only a more or less large portion of the surfaces require aftertreatment, and it may be the case that there is no need for any remediation work.

Surprisingly, in the case of the procedure according to the invention, the coating after the thermal curing possesses a moderate level of hardness and scratch resistance which is highly suitable for the step of eliminating quality deficiencies and which can be increased further by the subsequent step of UV exposure. Only in this aftercure is the ultimate hardness suitable for application attained.

After the thermal cure (step b) the coating has a strength which is sufficient for further processing, in particular for the repair of quality deficiencies. Typically this strength exists when the coating is at least dry to the touch. This level of hardness is below what is usual for high-grade automotive coatings.

The first curing step (step b) includes a free-radical polymerization which is initiated by thermal initiators. The thermal energy in this case may take place by direct heating of the substrate, by hot gas, by thermal radiation or by other known measures.

The amount of the initiators in the coating formulation is situated at the levels which are customary for thermal polymerizations. Typically initiator amounts of 0.5 to 5% by weight are used.

It is known that the polymerization is inhibited by the influence of atmospheric oxygen, which has an adverse effect on surface curing particularly in the case of thin coating films. In one preferred embodiment of the invention, therefore, thermal curing takes place under a reduced oxygen partial pressure. Preferably the coating film is cured under the influence of a low-oxygen or virtually oxygen-free inert gas, such as CO₂ or N₂, for example.

The extent of the effect of oxygen as inhibitor is also dependent on the chosen thermal initiator system. Where azo compounds or peroxo compounds, and also C—C-cleaving systems, are used as initiators, curing under a reduced oxygen partial pressure represents the preferred version of the method.

The suitable thermal free-radical initiators include organic azo compounds, organic peroxides and C—C-cleaving initiators, such as benzpinacol silyl ethers.

Suitable representatives of the peroxo compounds are diacyl peroxides, peroxycarboxylic esters, peroxydicarbonates, perketals, dialkyl peroxides, peroxocarboxylic acids and their esters, ketone peroxides and/or hydroperoxides, especially di(3,5,5-trimethylhexenoyl) peroxide, didecanoyl peroxide, dilauroyl peroxide, dibenzoyl peroxide, di(2-ethylhexyl) peroxydicarbonate, dicyclohexyl peroxodicarbonate, di(4-tert-butylcyclohexyl) peroxydicarbonate, dimyristyl peroxydicarbonate, diacetyl peroxydicarbonate, di-tert-butyl peroxyoxalate, and also peroxycarboxylic esters from the products of reaction between pivalic acid, neodecanoic acid or 2-ethylhexanoic acid and tert-butyl hydroperoxide, tert-amyl hydroperoxide, cumyl hydroperoxide, 2,5-dimethyl-2,5-dihydroperoxyhexane, 1,3-di(2-hydroxy-peroxyisopropyl)benzene.

The particularly suitable thermal free-radical initiators include the azo compounds, especially 2,2′-azobis(4-methoxy-2,4-dimethylvaleronitrile), 2,2′-azobis(2,4-dimethylvaleronitrile), 2,2′-azobis(2-methylbutyronitrile), 2,2′-azobis(N-(2-propenyl)-2-methylpropionamide) and/or dimethyl 2,2′-azobis(2-methylpropionate) (dimethyl 2,2′-azoisobutyrate). Further suitable free-radical initiators include benzpinacol silyl ethers.

A significant advantage of the method of the invention is that steps b) and d) of the method need not take place immediately after one another in time. Instead the thermally cured coating can be stored for a relatively long time and/or worked on without loosing its capacity to be aftercured by UV exposure.

Thus, for example, it is possible to remove the coated and thermally cured component from the production line if quality deficiencies are ascertained, to store it for a time and to pass it on for subsequent remediation. The period of time between steps b) and d) is preferably restricted to a duration of 1 minute to several days, in particular 10 days.

One preferred version of the method envisages examining the coated component for quality deficiencies online immediately after it has left the thermal curing station, with those components not subject to quality objections being passed on directly to the UV exposure station, and those components where there are objections being removed. At the UV exposure stage, those components for which there are no objections are preferentially still at an elevated temperature.

In accordance with the invention the coating formulation used for the method is free-radically polymerizable under thermal initiation. This does not by any means rule out the contribution of further curing mechanisms to curing the coating material in this step of method.

With preference, however, the method of the invention envisages the polymerization in step b) being initiated substantially by thermal free-radical initiators.

As free-radically curable components the coating formulation includes monomers containing ethylenically unsaturated groups. By monomers are meant also, below, prepolymers or oligomers which are suitable correspondingly for polymerization. These monomers are generally also known as binders of the coating formulation. The preferred ethylenically unsaturated groups, or monomers, respectively, include, in particular, (meth)acrylates, vinyl esters, vinyl ethers, acrylamides, vinyl chloride, acrylonitrile, butadiene, unsaturated fatty acids, styrene derivatives, maleic acid groups or fumaric acid groups. Typical oligomeric representatives which carry these reactive groups are polyesters, polyurethanes, alkyd resins, epoxides, polyethers or polyolefins. Particular preference is given to multiply (meth)acrylate-substituted monomers and oligomers. Preferably 10% to 99% by weight of the monomers containing ethylenically unsaturated groups are formed by acrylate compounds.

In one preferred coating formulation the monomers comprise polyfunctional compounds. These include, in particular, acrylate-modified isocyanurates obtainable from the reaction of a pentaerythritol derivative of the formula (4) with an isocyanurate radical of the general formula (5). The addition compounds of the two reactants (4) and (5) are formed by a condensation reaction between the free hydroxyl group or groups of the compound of the formula (4) and the isocyanate groups of the compound of the formula (5).

General formula of the pentaerythritol derivative:

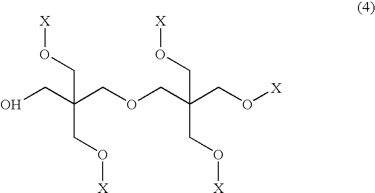

with X=—CO—CH═CH₂ or —CₙHₘ or —CO═CₙHₘ, where —CₙHₘ=aliphatic radical having 1 to 3 carbon atoms, with 0, 1, 2 or 3 substituents X being formed by —CₙHₘ and/or —CO—CₙHₘ.

In one particularly preferred embodiment all of the substituents X simultaneously are formed by —CO—CH═CH₂. The compound formed as a result of this is also referred to dipentaerythritol pentaacrylate.

The general formula of the isocyanurate radical is as follows:

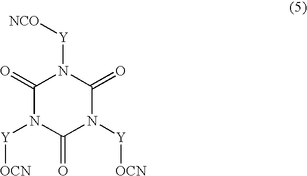

In this formula Y is an organic molecule chain having a length of 3 to 8 atoms, the organic molecule chain of Y having at least 3 C atoms (carbon atoms) and the heteroatoms that may additionally be present being formed by N, O and/or S. In one preferred embodiment the molecule chain Y is an aliphatic radical; with particular preference the molecule chain consists of 6 methylene groups.

A further preferred polyfunctional monomer is dipentaerythritol hexaacrylate.

The preferred monomer content is situated in the range from 5 to 55% by weight of the coating formulation, more preferably 20% to 40% by weight.

As further components the coating formulation may include compounds of relatively high molecular mass (prepolymers) which are copolymerizable. The preferred prepolymers include di-, tri-, tetra- or hexa-functional urethane acrylates which are synthesized by reacting (poly)isocyanates with hydroxyalkyl (meth)acrylates. A distinction is made between aliphatic and aromatic urethane acrylates, depending on the nature of the isocyanate used. In the case of the aromatic types the isocyanate used is predominantly tolylene diisocyanate (TDI) or diphenylmethane diisocyanate (MDI). Aliphatic isocyanates that are suitable are, in particular, isophorone diisocyanate (IPDI) or hexamethylene diisocyanate (HDI) and also its higher polymers (biuret, isocyanurates, etc.).

The coating formulation may if desired include solid fillers (adjuvants), which are able to produce a further improvement in the mechanical properties in particular. Suitable fillers include organic polymers or inorganic substances. Particularly suitable here are polyacrylates, polymethacrylates or glasses. Particularly preferred fillers are the polymeric products from the monomers of the binders used in the corresponding coating formulation. The fillers are usually very fine powders having average particle sizes below 5 μm, or nanopowders.

As a further component the coating formulation may further comprise UV stabilizers, which reduce the damage known to affect polymers and caused by intense sunlight or UV light. This is particularly significant in the context of use as a vehicle finish, since the coating material ought to be resistant to weathering and ought to be able to be used outdoors. The UV stabilizers are usually formed by UV absorbers, which absorb the UV light in the cured coating material and emit it again at a longer wavelength. The absorption region is preferably in the range from 200 to 400 nm. In accordance with the invention use is made in particular of absorbers based on benzophenones, alpha-hydroxy benzophenones, benzotriazoles, alpha-hydroxy benzotriazoles, benzoates, oxanilides or salicylates. The preferred fraction of the absorbers is situated in the range from 0.5% to 5% by weight.

Further possible components of the coating formulation include organic solvents in amounts from 1% to 50% by weight. The particularly suitable solvents include xylene and/or butyl acetate.

After the thermally cured coating films have worked on, the invention envisages the curing of the coating material to completion by means of UV exposure.

In this context it is an essential point that the coating formulation no longer requires any UV initiators for curing to completion. This constitutes a significant advantage over dual-cure coating materials which contain UV initiators, since prior to the UV exposure operation those coating materials can be handled only under special lighting which excludes UV light. Otherwise the UV initiators would undergo decomposition and the coating would undergo further curing on ingress of light, especially sunlight.

In accordance with the invention, therefore, steps of the method between b) and d) can be carried out, advantageously, without special precautionary measures. In particular, in the course of quality examination and the elimination of quality deficiencies (step c), the coating can be readily exposed to normal lighting or else to sunlight.

It is therefore preferred to use coating formulations which are substantially free from UV initiators.

The UV exposure of the invention is in accordance with the common techniques for the curing of UV coating materials. Irradiation with UV light takes place preferably with UV emitters, the radiation maximum of the UV source being preferably in the range from 100 to 400 nm. The wavelength distribution of the light used for curing preferably includes fractions of well above 220 nm, more preferably up to 500 nm.

UV exposure is carried out in such a way that there is a marked increase in hardness and/or scratch resistance as compared to the thermally cured coating material. Preferably step d) is carried out such that it leads to a coating hardness which is higher by at least 15% than immediately after step b).

Surprisingly it has been found in accordance with the invention that for the curing in step d) by means of UV exposure there is no need either for UV initiators or for thermal initiators. This means that for the aftercure in step d) it is not necessary to provide additional UV initiators in the coating formulation. Likewise, the initiators for step b) (thermal curing), which can be initiated both thermally and with induction by light, have substantially undergone reaction. The latter initiator includes, among others, certain azo compounds.

Preferably, therefore, the thermal curing is carried out to a point such that the thermal initiator has substantially undergone reaction, particularly until the concentration of the thermal free-radical initiator has dropped at least to below 0.1% of its initial level. This can generally be achieved by carrying out the thermal curing in step b) for at least a duration of 10 times the half-life of the added thermal free-radical initiator at the corresponding operating temperature.

A further aspect of the invention relates to a coating formulation suitable for the method of the invention, the coating formulation comprising monomers containing ethylenically unsaturated groups and also thermal free-radical initiators.

The invention envisages that the coating formulation is substantially free from UV initiators and that the hardness of the coating after thermal curing and subsequent UV irradiation is higher by about 15% than after thermal curing without UV irradiation.

Preferred coating formulations include as essential components:

thermal initiators: 1% to 5% by weight

monomers containing ethylenically unsaturated groups (binders): 30%-90% by weight

UV absorbers and free-radical scavengers (HALS): 0.5% to 5% by weight

solvents: 5% to 50% by weight

### EXAMPLES

A cured coating film was produced starting from a coating material whose composition was as follows:

thermal initiator:
azo initiator V601 from Wako Chemicals, based on dimethyl 2,2′-azobisisobutyrate

binder containing ethylenically unsaturated groups:
acrylate monomer: 10% by weight
di- and trifunctional urethane acrylates (synthesizable by reacting (poly)isocyanates with hydroxyalkyl acrylates): 20% by weight
dipentaerythritol hexaacrylate: 20% by weight

reactive oligomer of dipentaerythritol pentaacrylate (obtainable from reaction of a pentaerythritol derivative of the formula (4) with an isocyanurate radical of the general formula (5), all of the substituents X being formed simultaneously by —CO—CH═CH₂): 20% by weight

UV absorbers and free-radical scavengers (HALS): 1% by weight

butyl acetate solvent: remainder to 100% by weight

This coating material was applied in a thickness of a few μm by knifecoating to a number of samples with metallic substrate. This was followed by thermal curing at 130° C. under inert gas.

Two sets of experiments were run, with a cure time of 25 minutes (cf. experimental results FIG. 1) and a cure time of 90 minutes (cf. experiment results FIG. 2).

The precured samples from the two sets of experiments were then stored in air for different times and subsequently irradiated with UV light. The UV output was approximately 3000 j/mm².

### BRIEF DESCRIPTION OF THE DRAWINGS

After this the universal hardness of the coating films was measured. The results are plotted as graphs, and

FIG. 1 shows the course of the universal hardness in N/mm² as a function of the depth of measurement for the comparison sample with a thermal cure at 130° C. for 25 minutes without UV aftercure (1), for the comparison sample with immediately subsequent UV curing (2), for the comparison sample with UV curing after storage for 24 h (3), and for a comparison sample with UV curing after storage for 3 days; and

FIG. 2 shows the course of the universal hardness in N/mm² as a function of the depth of measurement for the comparison sample with a thermal cure at 130° C. for 90 minutes without UV aftercure (1′), for the comparison sample with immediately subsequent UV curing (2′), for the comparison sample with UV curing after storage for 24 h (3′), and for a comparison sample with UV curing after storage for 3 days (4′).

### DETAILED DESCRIPTION OF THE INVENTION

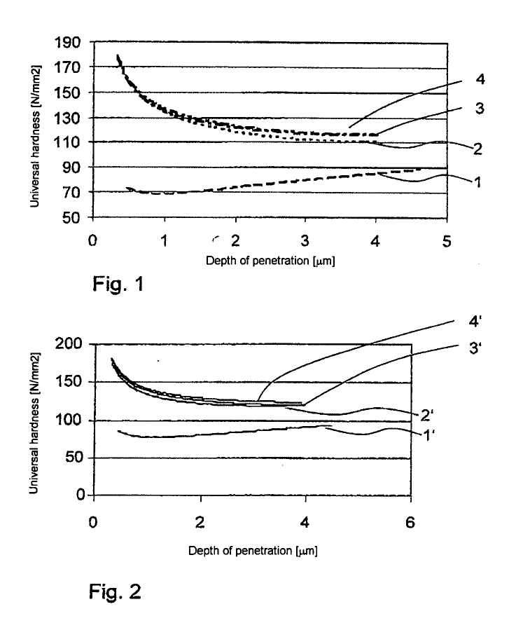

From FIG. 1 it is evident that the hardness of the surface layer can be increased significantly by means of the UV aftercure. While the sample cured only thermally (1) has a hardness value of 70 N/mm² directly at the surface, all three samples aftercured with UV light (2, 3 and 4) have a hardness which, at 170 N/mm², is more than twice as high. The hardness here, or the course of hardness in the depth, of the film of the aftercured samples does not exhibit any significant difference for the different periods of storage.

FIG. 2 also shows the course of the hardnesses, which basically is the same. In this case, however, the initial levels of hardness, at about 90 N/mm², are somewhat higher than in the case of the samples of FIG. 1, since at 90 minutes the thermal cure carried out was longer than the corresponding 25 minutes. For this higher initial hardness level as well it is possible to achieve virtually a doubling in hardness by virtue of the aftercure.

1. A method of producing coating films from coating formulations which are free-radically polymerizable under thermal initiation, wherein it comprises at least the following steps:
a) coating of the substrate with the coating formulation
b) thermally initiated curing of the coating formulation
c) elimination of quality deficiencies in the cured coating material
d) curing of the coating material to completion by UV exposure.

2. The method according to claim 1, wherein the elimination of quality deficiencies includes repair of coating defects and/or polishing of the coating.

3. The method according to claim 2, wherein the quality examination includes a local recoating.

4. The method according to claim 1 or 2, wherein the coating after step b) is at least dry to the touch.

5. The method according to claim 1 wherein step b) is carried under reduced oxygen partial pressure.

6. The method according to claim 1 wherein between steps b) and d) the coating is stored for a period of 1 minute up to 10 days.

7. The method according to claim 1 wherein monomers containing ethylenically unsaturated groups are used as free-radically curable components in the coating formulation.

8. The method according to claim 1 wherein the polymerization in step b) is initiated substantially by means of thermal free-radical initiators.

9. The method according to claim 8, wherein free-radical initiators are selected from at least one compound from the group 2,2′-azobis(4-methoxy-2,4-dimethylvaleronitrile), 2,2′-azo-bis(2,4-dimethylvaleronitrile), 2,2′-azobis(2-methylbutyronitrile), 2,2′-azobis(N-(2-propenyl)-2-methylpropionamide) and/or dimethyl 2,2′-azobis(2-methylpropionate, dimethyl 2,2′-azobisisobutyrate), di(3,5,5-trimethylhexenoyl) peroxide, didecanoyl peroxide, dilauroyl peroxide, dibenzoyl peroxide, di(2-ethylhexyl) peroxydicarbonate, dicyclohexyl peroxodicarbonate, di(4-tert-butylcyclohexyl) peroxydicarbonate, dimyristyl peroxydicarbonate, diacetyl peroxydicarbonate, di-tert-butyl peroxyoxalate and/or the group of the benzpinacol silyl ethers.

10. The method according to claim 1, wherein coating formulations are used which are substantially free from UV initiators.

11. The method according to claim 1, wherein step d) leads to a hardness in the coating that is higher by at least 15% than immediately after step b).

12. The method according to claim 1, wherein the thermal curing in step b) is carried out until the concentration of the thermal free-radical initiators has fallen to below 0.1% of their initial value.

13. The method according to claim 1, wherein the thermal curing in step b) is carried out for a period of 10 times the half-life of the added thermal free-radical initiators at the corresponding operating temperature.

14. A coating formulation suitable for a method of producing coating films from coating formulations which are free-radically polymerizable under thermal initiation, the method comprising coating of the substrate with the coating formulation, thermally initiated curing of the coating formulation, elimination of quality deficiencies in the cured coating material, and curing of the coating material to completion by UV exposure, the coating formulation comprising monomers containing ethylenically unsaturated groups and thermal free-radical initiators, wherein the coating formulation is substantially free from UV initiators and wherein the hardness of the coating material after thermal curing and subsequent UV irradiation is higher by at least 15% than after thermal curing without UV irradiation.

15. The coating formulation according to claim 14, wherein the formulation includes at least the following components:
30%-90% of monomers containing ethylenically saturated groups
1% to 5% by weight of thermal initiators.
